(19) United States
(12) Patent Application Publication
(10) Pub. No.: US 2002/0171071 A1
(43) Pub. Date: Nov. 21, 2002

(54) Cable winch hoisting device for stages

(76) Inventors: Reind Brackman, Weesp (NL); Theodor Helmle, Ellwangen (DE); Roland Koblinger, Backnang (DE); Servaas Tullemans, Amsterdam (NL)

Correspondence Address: COLLARD & ROE, P.C., 1077 Northern Boulevard, Roslyn, NY, 11576-1696, US

(21) Appl. No.: 10/102,198

(22) Filed: Mar. 20, 2002

(30) Foreign Application Priority Data
Mar. 21, 2001 (DE) 101 13 895.4

(51) Int. Cl. B66D 1/36

(52) U.S. Cl. 254/280

(57) ABSTRACT

A cable winch hoisting device for theatrical stages, whereby a plurality of elongated, rod-like holding girders are suspended on cables, and these holding girders are adjustable in height by varying the free cable length between the cable suspension and the holding girder, which determines the position of the respective holding girder. The holding girders are adjustable in height between two end positions without any mutual interference in the clearance spaces which do not overlap with one another and are provided for the holding girders. At least two cables which are uniformly adjustable by the same cable-operating device act on the holding girders and are distributed over the length of the girders. The cable-operating devices are each electrically driven cable drums. The cables acting on the same holding girder can be wound up side by side onto the cable drum of the respective cable-operating device with the same change in free cable length, which determines the position of the holding girder. The device is designed to be especially space-saving and functionally versatile with a simple structural design.

### BACKGROUND OF THE INVENTION

Field of the Invention

This invention relates to a cable winch hoisting device for theatrical stages. The invention solves the problem of designing such a device so that it has a simple, space-saving construction and can be operated in an abundant variety of functions.

### SUMMARY OF THE INVENTION

The invention comprises a winch hoisting device for theatrical stages, whereby a plurality of elongated, rod-like holding girders are suspended on cables, and these holding girders are adjustable in height by varying the free cable length between the cable suspension and the holding girder, which determines the position of the respective holding girder. The holding girders are adjustable in height between two end positions without any mutual interference in the clearance spaces which do not overlap with one another and are provided for the holding girders. At least two cables which are uniformly adjustable by the same cable-operating device act on the holding girders and are distributed over the length of the girders. The cable-operating devices are each electrically driven cable drums. The cables acting on the same holding girder can be wound up side by side onto the cable drum of the respective cable-operating device with the same change in free cable length, which determines the position of the holding girder. The device is designed to be especially space-saving and functionally versatile with a simple structural design.

The invention is based on the general idea of using drive devices with an especially shallow design in cable-operating devices, and having these drive devices encompassed as completely as possible by a respective bowl-shaped cable drum. The width of the cable-operating devices in the axial direction of the drums is determined essentially by the width of the drums. In this way, the multiple cables required for a holding girder run in close proximity, where each drum of a cable-operating device guides all the cables belonging to one hoisting girder.

In the case of holding girders in close proximity to one another to be mounted on the stage space, the cable-operating devices according to this invention can be designed in rows situated one above the other with cables guided in planes one above the other. With the arrangement in two rows lying one above the other, the cable-operating devices can be arranged with an offset with a mutual gap. The cables from the cable-operating devices in the lower row respectively may be passed beneath the cable-operating devices and their fastenings in the row above that with no problem. The cables may also be guided in different planes after horizontal deflection at the upper end of the stage space.

The cable-guiding drums of the cable-operating devices may preferably be made of plastic.

Mechanically operable means for emergency operation of the brakes of these operating devices can project outward through the gaps between cable-operating devices situated side by side.

The respective drive device of the cable-operating devices may be a synchronous motor which is energized by a permanent magnet and whose torque is transmitted via a gear to the cable drum. The gear is expediently designed as a planetary gear.

Each drive device may be equipped with an independent, integrated frequency regulator. However, an especially advantageous design is one in which several drive devices are operated with the same frequency regulator and a circuit using a bus system, for example, is provided for this purpose.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows a section through a stage space with a sectional view of cable drums of the cable-operating devices;

FIG. 2 shows a section through the stage space according to line II-II in FIG. 1;

FIG. 3 shows a view of a side wall of the stage space according to the arrow III in FIG. 1; and

FIG. 4 shows a view in the direction of the arrow IV of the cable-operating devices illustrated in FIG. 3.

### DETAILED DESCRIPTION OF THE PREFERRED EMBODIMENT

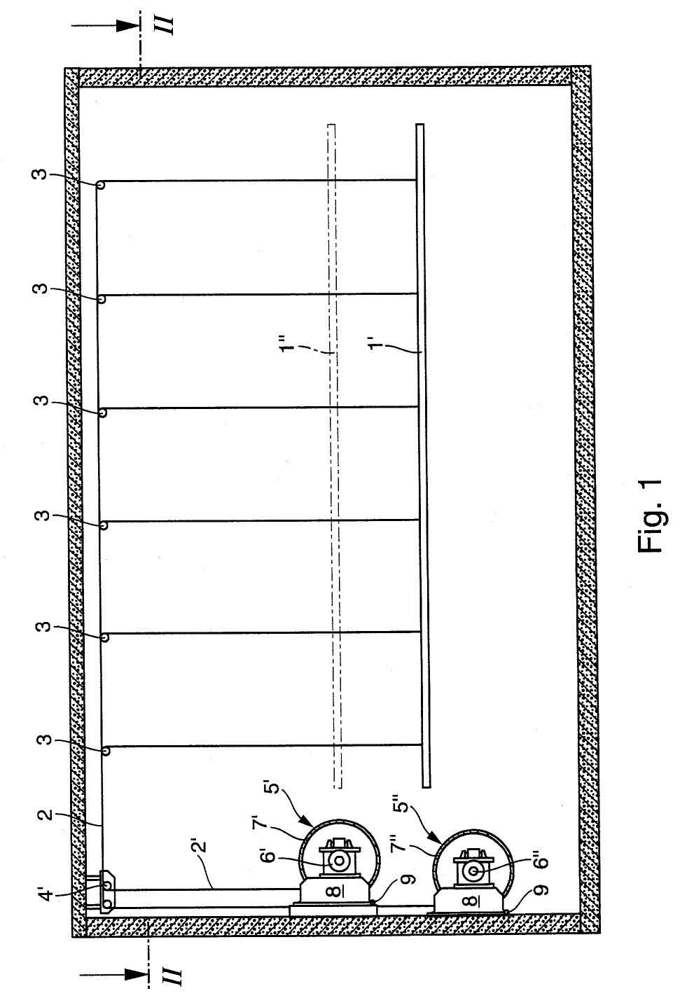

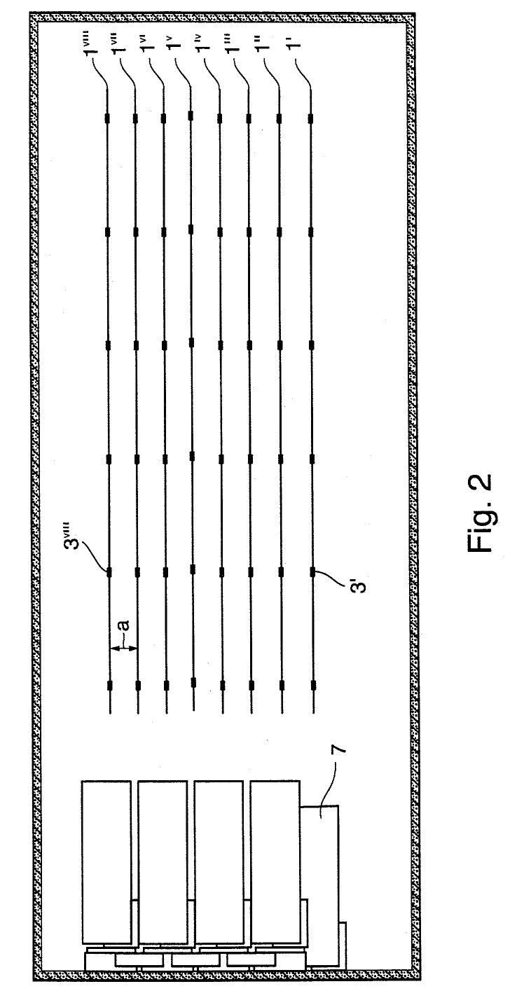

Referring now in detail to the drawings, FIGS. 1 and 2 show a theatrical stage space in which there are holding girders 1 which are mounted in close proximity to one another, distributed over the entire stage surface, so they are adjustable in height. These holding girders 1 are each suspended on multiple cables 2 distributed over the length of the girders. These cables 2 are each guided over deflection pulleys 3 which are mounted in the area of the upper stage space to yield a horizontal course and then can run to a cable-operating device 5 mounted on a side wall of the stage over additional deflection pulleys 4 mounted in the upper area of this side wall on the whole, a corresponding number of cable-operating devices 5 is allocated to a certain number of holding girders 1. All cables 2 connected to one holding girder 1 run toward a common cable-operating device 5.

Each cable-operating device 5 consists of an electrically operated drive device 6 which is shallow in the axial direction, a cable drum 7 which encompasses the drive device 6 completely around the circumference and almost completely in the axial direction as well as fastening means 8 for fastening to a side wall of the stage.

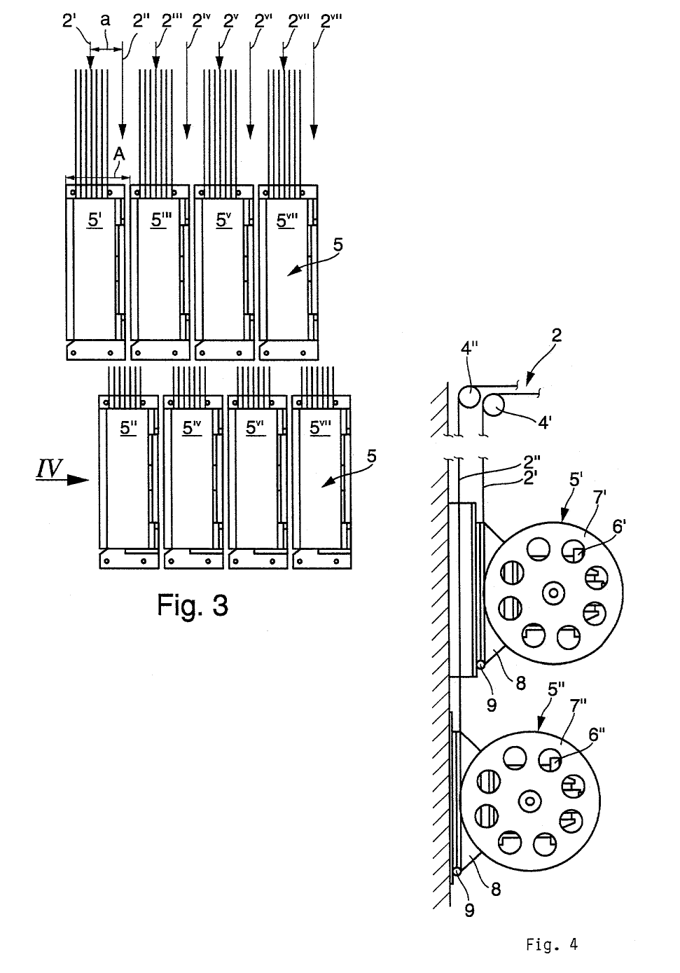

The cable-operating devices 5 are mounted on the side wall of the stage in two rows one above the other as shown in FIG. 4 such that the cable-operating devices 5 in the upper row are mounted so they are offset with a gap relative to those in the lower row (see FIG. 3). In addition, the cable-operating devices 5 of the upper row are mounted with a distance from the side wall of the stage with respect to those of the lower row (FIG. 4). Therefore, the cables 2 of the cable-operating devices 5 from the two rows may run in different planes and may partially cover one another with respect to a mutual projection of the cable surfaces.

The horizontal distances a between the holding girders 1 may amount to 200 mm. In this case, the total width A of the cable-operating devices 5 including a distance from an adjacent cable-operating device may amount to 400 mm. At any rate, an extremely small portion projects laterally out of the cable drums 7. The gap between the individual cable-operating devices 5 side by side may be used to permit operation of the mechanical transmission means for operation of a brake, which is to be operated in the event of an emergency, of the drive device 6 of the cable-operating device 5.

Essentially the drive devices 6 may be equipped with a synchronous motor which is energized by a permanent magnet and which transmits its torque via a gear, in particular a planetary gear, to the cable drum 7.

For maintenance of the cable-operating devices 5, they may be mounted so they are each foldable about an axis 9 in the direction of the cable.

Accordingly, while only a few embodiments of the present invention have been shown and described, it is obvious that many changes and modifications may be made thereunto without departing from the spirit and scope of the invention.

What is claimed is:

1. A cable winch hoisting device for theatrical stages, comprising:
a plurality of elongated, rod-like holding girders, said holding girders being adjustable in height between two end positions without mutual hindrance in clearance spaces that do not overlap mutually and are allocated to the holding girders;
at least two cables, each cable being uniformly adjustable by a cable-operating device, said cables acting on the holding girders and distributed over their length, wherein said holding girders are suspended on said cables and are adjustable in height by altering a free cable length between a cable suspension and the holding girder, determining the position of the respective holding girder;
a cable drum within each cable-operating device, wherein said cables acting on one of said holding girders are wound up side by side onto said cable drum of the respective cable-operating device with a same change in free cable length which determines the position of the holding girder, said cable drums being designed in a bowl shape and accommodating in their interior almost completely a drive device which is necessary for electric drive and is functional independently of the cable drums;
wherein several cable-operating devices are each arranged in a stationary mount side by side horizontally in close proximity, and wherein the cable-operating devices are situated side by side in a direction of axes of their cable drums.

2. A hoisting device according to claim 1, wherein when the horizontal distances a between the holding girders is up to 300 mm, the cable-operating devices have a maximum width A of 600 mm, including a distance from an adjacent device in the same row.

3. The hoisting device according to claim 2, wherein when the distance a between the holding girders is up to 250 mm, a respective width A of the cable-operating devices measures a maximum of 500 mm.

4. The hoisting device according to claim 2, wherein when the distance a between the holding girders is up to 200 mm, a respective width A of the cable-operating devices measures a maximum of 400 mm.

5. The hoisting device according to claim 4, wherein when the distance a between the holding girders is up to 150 mm, the respective width A of the cable-operating devices (5) measures a maximum of 300 mm.

6. The hoisting device according to claim 1, wherein the cable-operating devices are arranged in at least two rows one above the other, wherein a middle point of two drive devices situated side by side horizontally is allocated to a middle point of a drive device situated in the other row, wherein the cables of the cable-operating devices situated at different levels leave the respective cable drums at different levels, which are spanned by the cables of cable-operating devices arranged in a row.

7. The hoisting device according to claim 6, wherein areas taken up by the cables in planes in which said cables overlap run with respect to a mutual perpendicular projection of these areas.

8. The hoisting device according to claim 1, wherein the cable drum is made of plastic.

9. The hoisting device according to claim 1, wherein the drive devices are each equipped with a brake device, said brake device being operated by a mechanical operating means which extends through a gap between adjacent cable-operating devices.

10. The hoisting device according to claim 1, wherein the drive devices of the cable-operating devices each have a synchronous motor which is energized by a permanent magnet as a power source and which acts on a gear.

11. The hoisting device according to claim 10, wherein the gear is a planetary gear.

12. The hoisting device according to claim 1, wherein each drive device is equipped with an integrated, independent frequency regulator.

13. The hoisting device according to claim 1, wherein at least two drive devices are regulated in alternation by a single frequency regulator.

14. The hoisting device according to claim 1, wherein the cable-operating devices are each flipped out of a row association about a horizontal axis in a direction of the cable.
